(19) United States
(12) Patent Application Publication
(10) Pub. No.: US 2019/0107807 A1
(43) Pub. Date: Apr. 11, 2019

(54) IMAGE FORMING APPARATUS

(71) Applicant: TOSHIBA TEC KABUSHIKI KAISHA, Tokyo (JP)

(72) Inventors: Tadao Kamano, Izu Shizuoka (JP); Takashi Ogiwara, Numazu Shizuoka (JP)

(21) Appl. No.: 16/134,684

(22) Filed: Sep. 18, 2018

(30) Foreign Application Priority Data
Oct. 10, 2017 (JP) 2017-197150

(51) Int. Cl. G03G 21/20

(52) U.S. Cl. CPC G03G 21/206

(57) ABSTRACT

According to an embodiment, an image forming apparatus includes an air intake unit, a first blower path, a second blower path, and an air discharge unit. The air intake unit introduces air. The first blower path guides the air introduced by the air intake unit and cools the developer device. The second blower path ventilates an inside or a periphery of the charging device by using air guided from the first blower path. The air discharge unit discharges air guided from the second blower path to an outside of a predetermined range.

### CROSS-REFERENCE TO RELATED APPLICATIONS

This application is based upon and claims the benefit of priority from the prior Japanese Patent Application No. 2017-197150, filed on Oct. 10, 2017, the entire contents of which are incorporated herein by reference.

### FIELD

An embodiment to be described here generally relates to an image forming apparatus.

### BACKGROUND

An image forming unit of an image forming apparatus includes, for example, a photosensitive drum, a charging device, an exposing device, and a developer device. The photosensitive drum is electrically charged by the charging device. The exposing device exposes the electrically-charged photosensitive drum to light on the basis of image data. As a result, an electrostatic latent image is formed on the surface of the photosensitive drum. This electrostatic latent image is developed by the developer device. In other words, a toner image is formed on the surface of the photosensitive drum. The toner image on the photosensitive drum is transferred to a sheet via an intermediate transfer member, for example.

The image forming unit includes, for example, a first blower path for cooling the developer device. The charging device may generate ozone. The ozone has a possibility of acting on the photosensitive drum and adversely affecting the image. Therefore, the image forming unit may include a second blower path for discharging ozone, separately from the first blower path described above. Since the structure of the blower path or the like is complicated in the image forming apparatus having the structure described above, it has been difficult to achieve reduction in size. Further, there has been a demand for improvement in cost.

### BRIEF DESCRIPTION OF THE DRAWINGS

FIG. 1 is a diagram showing an image forming apparatus according to a first embodiment.

FIG. 2 is a perspective view showing an image forming unit of the image forming apparatus according to the first embodiment.

FIG. 3 is a perspective view showing the image forming units and a ventilation mechanism of the image forming apparatus according to the first embodiment when viewed from one side.

FIG. 4 is a perspective view showing the image forming units and the ventilation mechanism of the image forming apparatus according to the first embodiment when viewed from another side.

FIG. 5 is a view for describing the inner structure of the image forming unit according to the first embodiment.

FIG. 6 is a partial cross-sectional view showing the structures of the image forming unit and a communication path of the image forming apparatus according to the first embodiment.

FIG. 7 is a rear view showing the image forming units and the ventilation mechanism of the image forming apparatus according to the first embodiment.

FIG. 8 is a front view showing the image forming units and the ventilation mechanism of the image forming apparatus according to the first embodiment.

FIG. 9 is a perspective view showing image forming units and a ventilation mechanism of an image forming apparatus in a comparative embodiment.

FIG. 10 is a front view showing the image forming units and the ventilation mechanism of the image forming apparatus in the comparative embodiment.

FIG. 11 is a front view showing the image forming units and the ventilation mechanism of the image forming apparatus in the comparative embodiment.

FIG. 12 is a perspective view showing an image forming unit and a ventilation mechanism of an image forming apparatus according to a second embodiment.

### DETAILED DESCRIPTION

According to one embodiment, an image forming apparatus includes a photoreceptor, a charging device, an exposing device, a developer device, an air intake unit, a first blower path, a second blower path, and an air discharge unit. The charging device electrically charges a surface of the photoreceptor. The exposing device exposes the electrically-charged photoreceptor to light and forms an electrostatic latent image on the surface of the photoreceptor. The developer device develops the electrostatic latent image and forms a toner image on the surface of the photoreceptor. The air intake unit introduces air. The first blower path guides the air introduced by the air intake unit and cools the developer device. The second blower path ventilates an inside or a periphery of the charging device by using air guided from the first blower path. The air discharge unit discharges air guided from the second blower path to an outside of a predetermined range.

Hereinafter, an image forming apparatus of each embodiment will be described with reference to the drawings. In the drawings, the same reference symbols represent the same or similar units.

### First Embodiment

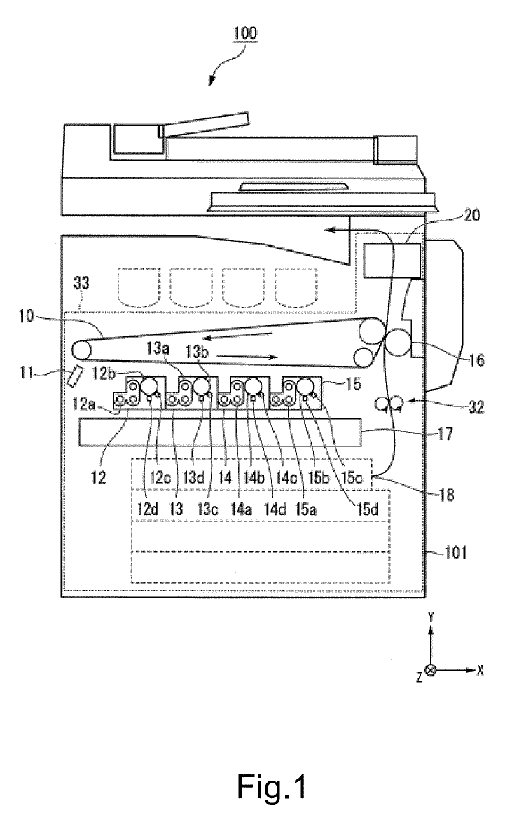

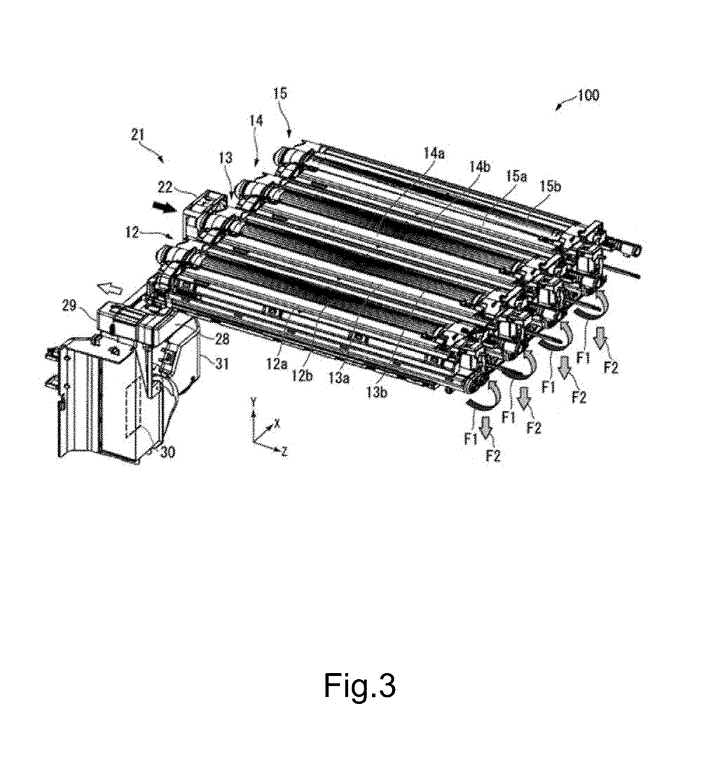

FIG. 1 is a view showing an image forming apparatus 100 of a first embodiment. As shown in FIG. 1, the image forming apparatus 100 is an electrophotographic image forming apparatus. The image forming apparatus 100 includes a printer 33, a controller 17, a ventilation mechanism 21 (see FIG. 3), and a casing 101. The printer 33 includes an intermediate transfer member 10, a blade 11 (toner remover unit), image forming units 12, 13, 14, and 15, a sheet-feeding device 18, resist rollers 32, secondary-transfer rollers 16, and a fixing device 20. As shown in FIG. 1, the controller 17 is provided within the printer 33, for example. The controller 17 controls the image forming apparatus 100. The printer 33 forms an image on a sheet. The casing 101 houses constituent elements of respective units of the printer 33, the controller 17, and the ventilation mechanism 21 (see FIG. 3).

The printer 33 of the image forming apparatus 100 forms electrostatic latent images on photosensitive drums 12b, 13b, 14b, and 15b on the basis of image information. The image forming apparatus 100 causes developers to adhere to the electrostatic latent images to thereby form visible images. For a specific example, toners are used as the developers.

The intermediate transfer member 10 is an endless belt. The visible images are transferred (primary-transferred) from the photosensitive drums 12b, 13b, 14b, and 15b to the intermediate transfer member 10 by a primary-transfer device. The intermediate transfer member 10 rotates in the direction of the arrows of FIG. 1 while holding the primary-transferred visible images, and conveys the visible images to the positions of the secondary-transfer rollers 16 (secondary-transfer position). The blade 11 removes toners, which adhere to the intermediate transfer member 10, after the secondary transfer is performed by the secondary-transfer rollers 16. The image forming units 12 to 15 form the visible images on the photosensitive drums 12b, 13b, 14b, and 15b by using toners of respective colors (four colors in the example of FIG. 1). The sheet, on which the images are to be formed, is conveyed, by the resist rollers 32 and the like, to the secondary-transfer position. The secondary-transfer rollers 16 transfer the visible images (toner images) held on the intermediate transfer member 10 on the sheet at the secondary-transfer position.

The controller 17 controls the sheet-feeding device 18, the image forming units 12 to 15, and the fixing device 20. The sheet-feeding device 18 feeds the sheet, on which the images are to be formed. The fixing device 20 heats the sheet. Specifically, the fixing device 20 heats and presses the sheet on which the toner images are formed, to thereby fix the toner images on the sheet.

The image forming apparatus 100 converts image data, which is the original data for forming images, into image data of respective colors by means of image processing. For example, the image forming apparatus 100 converts image data into image data of respective colors, i.e., yellow (Y), magenta (M), cyan (C), and black (K). The image forming units 12 to 15 multi-transfer toner images of the respective colors so as to overlap one another on the intermediate transfer member 10 in the primary transfer. Next, the secondary-transfer rollers 16 transfer the toner images on the intermediate transfer member 10 to the sheet. The secondary-transfer rollers 16 are an example of a transfer unit.

The sheet, on which images are to be formed, is fed from the sheet-feeding device 18 and is conveyed on a sheet conveying path. The sheet passes through the secondary-transfer position of the secondary-transfer rollers 16 and the fixing device 20, and is discharged to a discharge tray.

Next, the image forming units 12 to 15 will be described. The image forming units 12 to 15 form toner images on a medium (photosensitive drums 12b, 13b, 14b, and 15b). Specifically, the image forming unit 12 forms a black toner image on a medium (photosensitive drum 12b). The image forming unit 13 forms a yellow toner image on a medium (photosensitive drum 13b). The image forming unit 14 forms a magenta toner image on a medium (photosensitive drum 14b). The image forming unit 15 forms a cyan toner image on a medium (photosensitive drum 15b). In order to form the toner images of the respective colors as described above, the image forming units 12 to 15 include the photosensitive drums 12b, 13b, 14b, and 15b of the respective colors and also include processing units such as charging devices 12c, 13c, 14c, and 15c, exposing devices 12d, 13d, 14d, and 15d, and developer devices 12a, 13a, 14a, and 15a around the photosensitive drums 12b to 15b. In other words, the image forming units 12 to 15 have the same configuration except for the different toners to be used for forming the toner images. Therefore, for the image forming units 12 to 15, the image forming unit 12 will be described for an example.

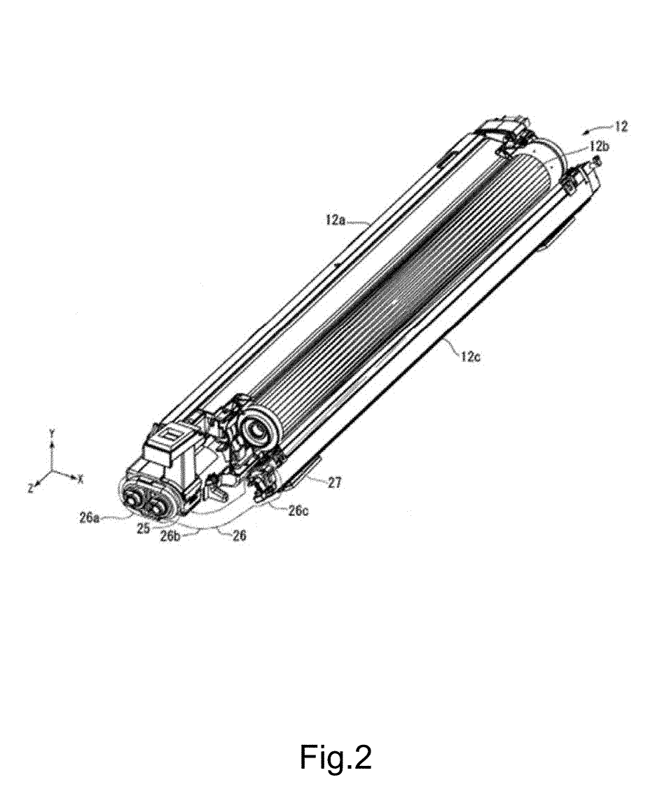

FIG. 2 is a perspective view showing the image forming unit 12. As shown in FIGS. 1 and 2, the image forming unit 12 includes the developer device 12a, the photosensitive drum 12b (photoreceptor), the charging device 12c, and the exposing device 12d (see FIG. 1). The developer device 12a houses a toner (yellow toner). The developer device 12a causes the toner to adhere to the photosensitive drum 12b, and thereby develops an electrostatic latent image formed on the photosensitive drum 12b. The developer device 12a develops an electrostatic latent image to thereby form a toner image on the photosensitive drum 12b. The photosensitive drum 12b is an image holding member. The photosensitive drum 12b is disposed to face the intermediate transfer member 10 and is rotated in a clockwise direction in FIG. 1. The photosensitive drum 12b has photoreceptors (photosensitive area) on its outer circumferential surface. The photoreceptors are, for example, organic photo conductors (OPC). The developer device 12a, the charging device 12c, and the exposing device 12d are disposed around the photosensitive drum 12b along the outer circumferential surface thereof. The charging device 12c electrically charges the surface of the photosensitive drum 12b uniformly by corona discharge, for example, before the development. The exposing device 12d irradiates the photosensitive drum 12b with light on the basis of the image data. The exposing device 12d includes a light source for exposure such as a laser or an LED.

The photosensitive drum 12b is electrically charged by the charging device 12c. Next, the exposing device 12d exposes the electrically-charged photosensitive drum 12b to light on the basis of image data of a yellow color. As a result of this exposure, an electrostatic latent image is formed on the surface of the photosensitive drum 12b. The electrostatic latent image corresponds to the image data of a yellow color. The developer device 12a develops the electrostatic latent image on the surface of the photosensitive drum 12b by using a yellow toner. In other words, a yellow toner image is formed on the surface of the photosensitive drum 12b. The toner image on the photosensitive drum 12b is transferred to the intermediate transfer member 10 by means of the field effect, for example (see FIG. 1).

As shown in FIG. 1, the controller 17 controls the drive of the photosensitive drums 12b, 13b, 14b, and 15b. The controller 17 further controls the drive of the developer devices 12a, 13a, 14a, and 15a and the charging devices 12c, 13c, 14c, and 15c.

Specifically, the controller 17 causes the exposing devices 12d, 13d, 14d, and 15d to expose the photosensitive drums 12b, 13b, 14b, and 15b to light on the basis of the image data of the respective colors. Further, the controller 17 causes the developer devices 12a, 13a, 14a, and 15a to develop electrostatic latent images and to form toner images of the respective colors on the photosensitive drums 12b, 13b, 14b, and 15b. The toner images of the respective colors formed on the photosensitive drums 12b, 13b, 14b, and 15b are transferred to the intermediate transfer member 10 by means of the field effect, for example.

The secondary-transfer rollers 16 transfer the toner images, which are transferred to the intermediate transfer member 10, to the sheet. The fixing device 20 heats and presses the sheet on which the toner images are formed, to thereby fix the toner images on the sheet. The controller 17 discharges the sheet, on which the images (toner images) are fixed, to the discharge tray.

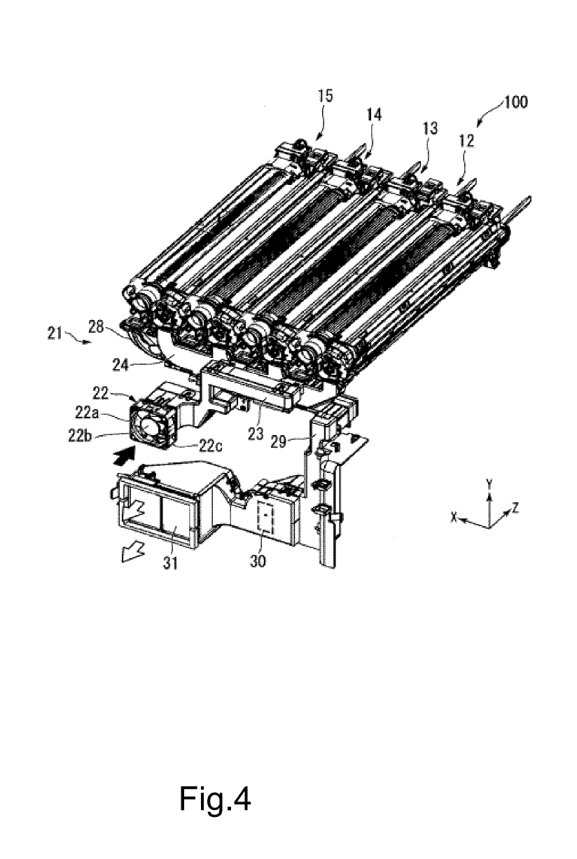

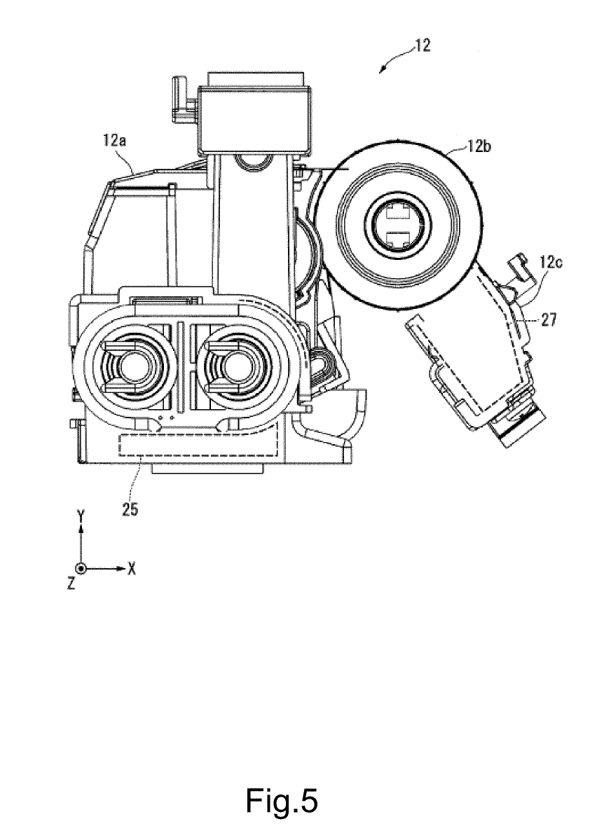

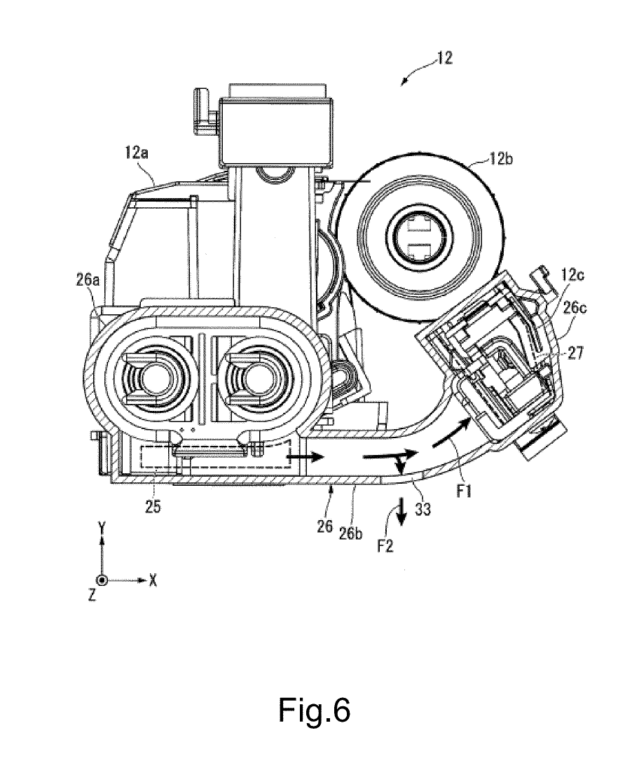

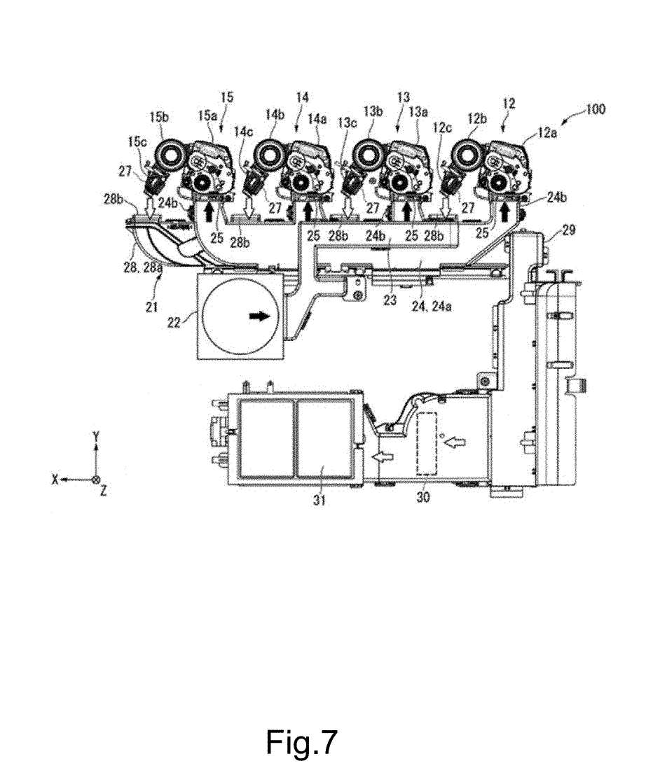

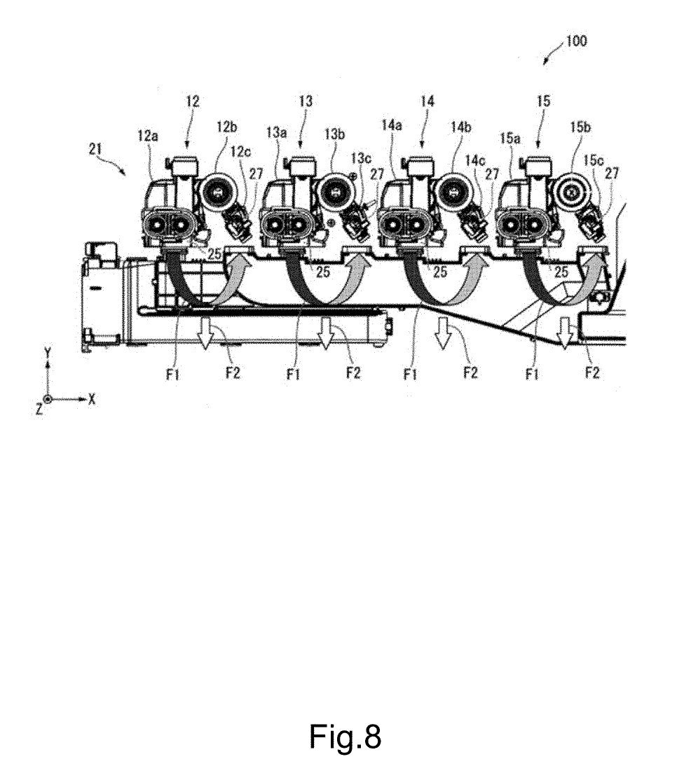

The ventilation mechanism 21 introduces air outside the casing 101 from one end side of each of the photosensitive drums 12b to 15b in a rotation axis direction (Z direction) and guides the introduced air to the developer devices 12a to 15a, to thereby cool the developer devices 12a to 15a. Further, the ventilation mechanism 21 guides the air guided to the developer devices 12a to 15a to the charging devices 12c to 15c from the developer devices 12a to 15a, and ventilates the inside or the periphery of the charging devices 12c to 15c, and discharges the air guided to the charging devices 12c to 15c from one end side of each of the photosensitive drums 12b to 15b in the rotation axis direction to the outside of the casing 101, for example. Hereinafter, the structure of the ventilation mechanism 21 will be described in detail. FIG. 3 is a perspective view showing the image forming units 12 to 15 and the ventilation mechanism 21 when viewed from one side. FIG. 4 is a perspective view showing the image forming units 12 to 15 and the ventilation mechanism 21 when viewed from another side (opposite to the one side). FIG. 5 is a view for describing the inner structure of the image forming unit 12. FIG. 6 is a partial cross-sectional view showing the structures of the image forming unit 12 and a communication path 26. FIG. 7 is a rear view showing the image forming units 12 to 15 and the ventilation mechanism 21. FIG. 8 is a front view showing the image forming units 12 to 15 and the ventilation mechanism 21.

As shown in FIGS. 3 to 4, the ventilation mechanism 21 includes an air intake unit 22, an introduction path 23 (see FIG. 4), a distribution path 24 (see FIG. 4), a first blower path 25 (see FIG. 5), the communication path 26 (see FIG. 6), a second blower path 27 (see FIG. 5), a guide path 28 (see FIG. 4), a discharge path 29 (see FIG. 4), an air discharge unit 30 (see FIG. 4), and an ozonation treatment unit 31 (see FIG. 4).

In FIGS. 3 to 4, the direction in which the image forming units 12 to 15 are arranged is the X direction. The length direction of the image forming units 12 to 15 (rotation axis direction of the photosensitive drums 12b to 15b) is the Z direction. The direction orthogonal to the X direction and the Z direction is the Y direction. The Z direction is the front-back direction of the image forming apparatus 100. Out of the end portions of the image forming unit 12 in the length direction, the end portion on the front side of the plane in FIGS. 5 and 6 is the front end portion (first end portion). The end portion opposite to the front end portion is the rear end portion (second end portion).

As shown in FIG. 4, the air intake unit 22 is an air intake fan that is provided on one end side of each of the photosensitive drums 12b to 15b in the rotation axis direction (Z direction) and introduces air outside the casing 101. The air intake unit 22 is an air intake fan including a fan member 22a, a shaft portion 22b, and an exterior package body 22c. The fan member 22a rotates together with the shaft portion 22b. As shown in FIG. 4 by the black arrow, the air intake unit 22 introduces air outside the casing 101 (see FIG. 1) into the casing 101.

As shown in FIG. 7, the introduction path 23 guides the air introduced by the air intake unit 22 to the distribution path 24. The distribution path 24 includes a main path 24a extending in the X direction, and a plurality of branched paths 24b. The plurality of branched paths 24b are branched from the main path 24a with intervals therebetween in the X direction. The plurality of branched paths 24b send air to the rear end portions of the first blower paths 25 (see FIG. 5) of the developer devices 12a to 15a of the image forming units 12 to 15 (see black arrows of FIG. 7). It should be noted that the introduction path 23 is formed of an introduction duct. The branched path 24b and the main path 24a are formed of a branch duct and a main path duct, respectively. The first blower path 25 is formed of a cooling duct. In the following description and figures, the paths 23, 24a, 24b, and 25 described above are assumed to include the above-mentioned ducts that form the respective paths.

As shown in FIG. 5, the first blower path 25 is formed within the developer device 12a of the image forming unit 12, for example. The first blower path 25 extends in the entire length of the developer device 12a in the length direction (Z direction). The first blower path 25 guides air, which is introduced from the rear end portion of the developer device 12a, to the front end portion. The first blower path 25 is formed into a duct shape, for example.

As shown in FIGS. 7 and 8, the first blower path 25 is formed also in each of the developer devices 13a to 15a of the image forming units 13 to 15, as in the developer device 12a of the image forming unit 12. The first blower path 25 causes the air, which is supplied from the distribution path 24, to circulate from the rear end portions toward the front end portions, to thereby cool the developer devices 12a to 15a. It should be noted that the first blower path is not limited to have the structure shown in FIG. 5 and may be provided on the outer surface side of each of the developer devices 12a to 15a. In such a case, the first blower paths cool the developer devices 12a to 15a from the outer surface side by using air flowing in the first blower paths.

As shown in FIG. 6, the communication path 26 includes a first attachment portion 26a, a second attachment portion 26c, and a connection path 26b. The first attachment portion 26a is attached to the front end portion of the developer device 12a. The second attachment portion 26c is attached to the front end portion of the charging device 12c. The connection path 26b connects the first attachment portion 26a and the second attachment portion 26c to each other. The connection path 26b is formed of a connection duct. It should be noted that, in the following description and figures, the connection path 26b is assumed to include the above-mentioned duct that forms the path. The connection path 26b causes the inner space of the first attachment portion 26a and the inner space of the second attachment portion 26c to communicate with each other. Therefore, the communication path 26 guides the air, which is guided from the front end portion of the first blower path 25, to the front end portion of the second blower path 27. In other words, the communication path 26 connects the first blower path 25 and the second blower path 27 in series.

As in the image forming unit 12, the communication path 26 (see FIG. 6) is provided to each of the front end portions of the image forming units 13 to 15 shown in FIG. 3. The communication path 26 guides the air, which is guided from the front end portion of the first blower path 25 of each of the developer devices 13a to 15a, to the front end portion of the second blower path 27 of each of the charging devices 13c to 15c (see FIGS. 3 and 8).

The second blower path 27 is formed of a ventilation duct. It should be noted that, in the following description and figures, the second blower path 27 is assumed to include the above-mentioned duct that forms the path. As shown in FIG. 5, the second blower path 27 is formed within the charging device 12c of the image forming unit 12, for example. The second blower path 27 extends in the entire length of the charging device 12c in the length direction (Z direction). The second blower path 27 guides air, which is introduced from the front end portion of the charging device 12c, to the rear end portion.

As shown in FIGS. 7 and 8, the second blower path 27 is formed also in each of the charging devices 13c to 15c of the image forming units 13 to 15, as in the charging device 12c of the image forming unit 12. The second blower path 27 causes the air, which is supplied from the communication path (see FIG. 6), to circulate from the front end portion toward the rear end portion, to thereby ventilates the inside of the charging devices 12c to 15c. It should be noted that the second blower path is not limited to have the structure shown in FIG. 5 and may be provided on the outer surface side of each of the charging devices 12c to 15c. In such a case, the second blower paths ventilate the periphery of the charging devices 12c to 15c by using air flowing in the second blower paths. The second blower path is formed in any one or both of the inside and the outer surface side of each of the charging devices 12c to 15c.

As shown in FIG. 6, the connection path 26b of the communication path 26 includes an discharge port 33. The discharge port 33 discharges part of the air flowing in the connection path 26b to the outside of the connection path 26b. The discharge port 33 adjusts the discharge amount of air on the basis of the size (inner diameter or the like) thereof. In other words, if the size (inner diameter or the like) of the discharge port 33 is small, the discharge amount of air decreases. If the size (inner diameter or the like) of the discharge port 33 is large, the discharge amount of air increases. In other words, the discharge port 33 is a flow rate adjustment structure that adjusts the flow rate of air sent to the second blower path 27.

It should be noted that the structure that adjusts the flow rate of air sent to the second blower path 27 is not limited to the discharge port 33. The structure that adjusts the flow rate of air may be, for example, a mechanism that circulates and uses the air of the second blower path 27.

As shown in FIGS. 4 and 7, the guide path 28 includes a main path 28a extending in the X direction, and a plurality of branched paths 28b. The main path 28a and the branched paths 28b are formed of a main path duct and branch ducts, respectively. It should be noted that, in the following description and figures, the main path 28a and the branched paths 28b are assumed to include the above-mentioned ducts that form the respective paths. The plurality of branched paths 28b are branched from the main path 28a with intervals therebetween in the X direction. Air guided from the rear end portions of the second blower paths 27 (see FIG. 5) of the charging devices 12c to 15c of the image forming units 12 to 15 is introduced into the plurality of branched paths 28b. The branched paths 28b guide the air guided from the plurality of second blower paths 27 to the main path 28a to collect the air. The guide path 28 sends the air to the discharge path 29 (see white arrows of FIG. 7).

The discharge path 29 guides the air, which is introduced from the guide path 28, to the air discharge unit 30. The air discharge unit 30 is, for example, a discharge fan that is provided on one end side of each of the photosensitive drums 12b to 15b in the rotation axis direction (Z direction) and discharges the air, which is guided from the inside or periphery of each of the charging devices 12c to 15c, to the outside of the casing 101. The air discharge unit 30 can send air to the ozonation treatment unit 31. The ozonation treatment unit 31 is, for example, an ozone filter. The ozone filter adsorbs and removes ozone in the air guided by the air discharge unit 30. The ozonation treatment unit 31 can reduce the ozone concentration of the air to be discharged (discharged air).

Next, a method of using the ventilation mechanism 21 of the image forming apparatus 100 will be described. As shown in FIG. 7, the controller 17 of the image forming apparatus 100 drives the air intake unit 22 to introduce air outside the casing 101 into the casing 101. The introduction path 23 and the distribution path 24 distribute and supply the introduced air to the rear end portions of the first blower paths 25 of the developer devices 12a to 15a (see black arrows of FIG. 7). The supplied air flows from the rear end portions of the first blower paths 25 toward the front end portions thereof. The air cools the developer devices 12a to 15a. It should be noted that the controller 17 of the image forming apparatus 100 also drives the air discharge unit 30.

As shown in FIG. 6, air guided from the front end portion of the first blower path 25 flows to the front end portion of the second blower path 27 by the communication path 26. FIGS. 3, 6, and 8 show flows F1 of air flowing from the front end portion of the first blower path 25 to the front end portion of the second blower path 27 through the communication path 26.

Since the communication path 26 includes the discharge port 33 (see FIG. 6), part of the air flowing in the communication path 26 is discharged to the outside. With this configuration, a flow rate of the air to be sent to the second blower path 27 can be adjusted. FIGS. 3, 6, and 8 show flows F2 of air to be discharged to the outside of the communication path 26 through the discharge port 33.

As shown in FIG. 8, the air supplied from the communication paths 26 flows from the front end portions toward the rear end portions of the second blower paths 27 of the charging devices 12c to 15c. The air ventilates the inside of each of the charging devices 12c to 15c. With this configuration, it is possible to prevent ozone generated in the charging devices 12c to 15c from acting on the photosensitive drums 12b to 15b and adversely affecting the images.

If the flow rate of the air flowing in the second blower path 27 is extremely large, the entrainment and dispersion of toners and dust are likely to occur in the charging devices 12c to 15c. If the flow rate of the air flowing in the second blower path 27 is extremely small, the ventilation is insufficiently performed, and there is a possibility that ozone acts on the photosensitive drums 12b to 15b and adversely affects the images. Therefore, it is desirable that the flow rate of the air sent to the second blower path is set to the range capable of performing sufficient ventilation and failing to entrain toners and the like. Meanwhile, in order to prevent the developers from being solidified in the developer devices 12a to 15a, it is desirable that the developer devices 12a to 15a are sufficiently cooled. The effect of cooling the developer devices 12a to 15a increases as the flow rate of air flowing in the first blower paths 25 becomes large.

By adjustment of the drive amount of the air intake unit 22, the ventilation mechanism 21 can sufficiently increase the flow rate of the air in the first blower path 25, and thus enhance the effect of cooling the developer devices 12a to 15a. Therefore, it is possible to prevent the developers from being solidified. As shown in FIG. 6, the discharge port 33 formed in the communication path 26 can adjust the flow rate of air to be introduced into the second blower path 27, and can thus optimize the flow rate of air flowing in the second blower path 27. Therefore, the ventilation mechanism 21 can sufficiently ventilate the charging devices 12c to 15c and prevent the entrainment and dispersion of toners and the like from occurring. Further, since the ventilation mechanism 21 can reduce the flow rate of the air in the second blower path 27, the emission of ozone can be suppressed.

As shown in FIG. 7, air guided from the rear end portions of the second blower paths 27 are sent to the discharge path 29 via the branched paths 28b and the main path 28a of the guide path 28. The air in the discharge path 29 is sent to the ozonation treatment unit 31 via the air discharge unit 30. After ozone is removed from the air, the air is discharged to the outside of the system (see white arrows of FIG. 7). It should be noted that the outside of the system is, for example, the outside of a predetermined range including the image forming units 12 to 15 and the like. More specifically, the outside of the system is, for example, the outside of the casing 101.

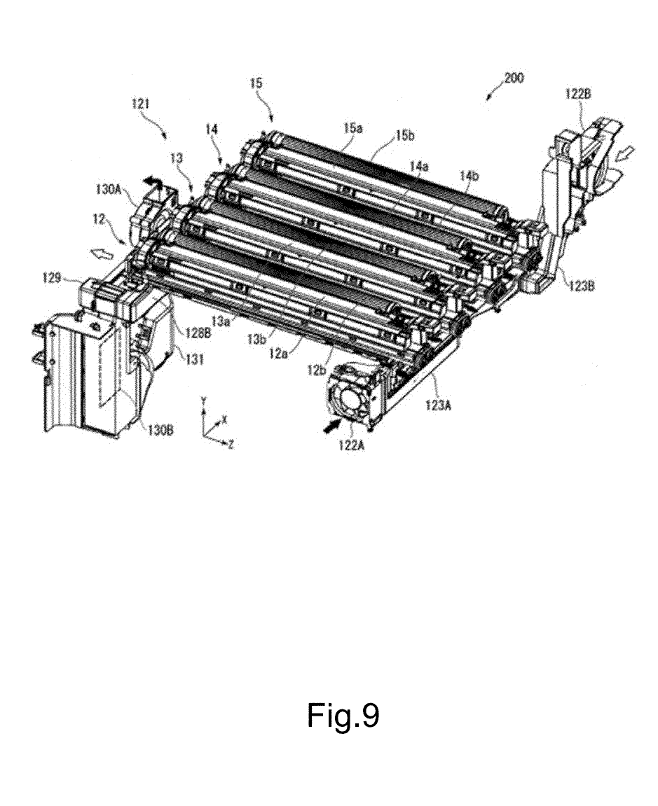

In the image forming apparatus 100, air guided from the first blower path 25 can be guided to the second blower path 27. In the image forming apparatus 100, air used for cooling the developer devices 12a to 15a can be reused for ventilating the charging devices 12c to 15c, and thus the structure of the ventilation mechanism 21 can be simplified. For example, the number of air intake units 22 and air discharge units 30 is smaller than the number of air intake units and air discharge units of an image forming apparatus 200 (see FIG. 9) in a comparative embodiment to be described later. Further, in the image forming apparatus 100, a flow-path structure on the front side of the image forming units 12 to 15 is simplified as compared with the image forming apparatus 200 (see FIG. 9). In the image forming apparatus 100, the number of air intake units 22 and air discharge units 30 is small, and thus the number of air inlets and air outlets formed in the casing 101 and the like can be reduced. Therefore, the image forming apparatus 100 can achieve reduction in size of the apparatus. Further, the image forming apparatus 100 includes the ventilation mechanism 21 having a simple structure, and can thus achieve reduction in cost.

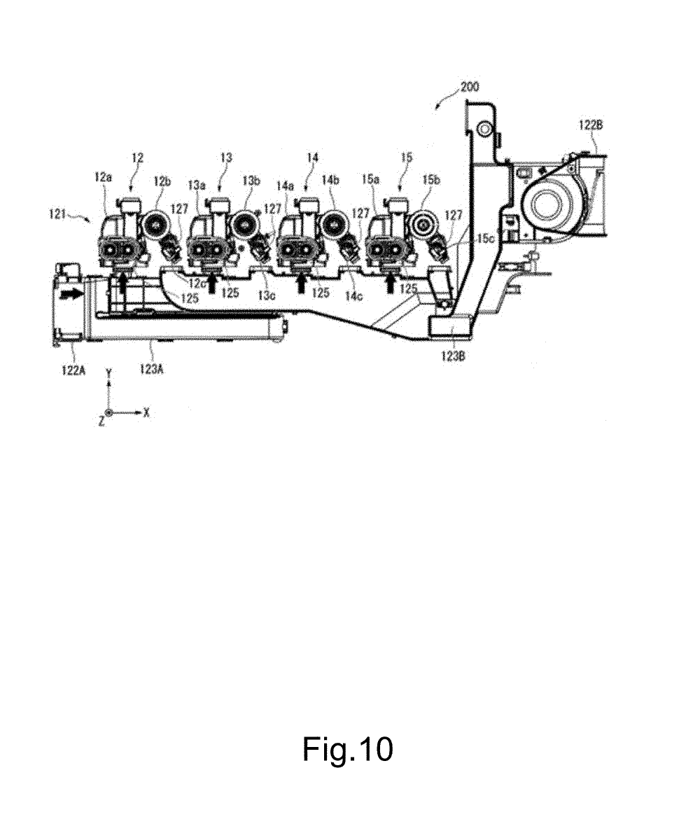

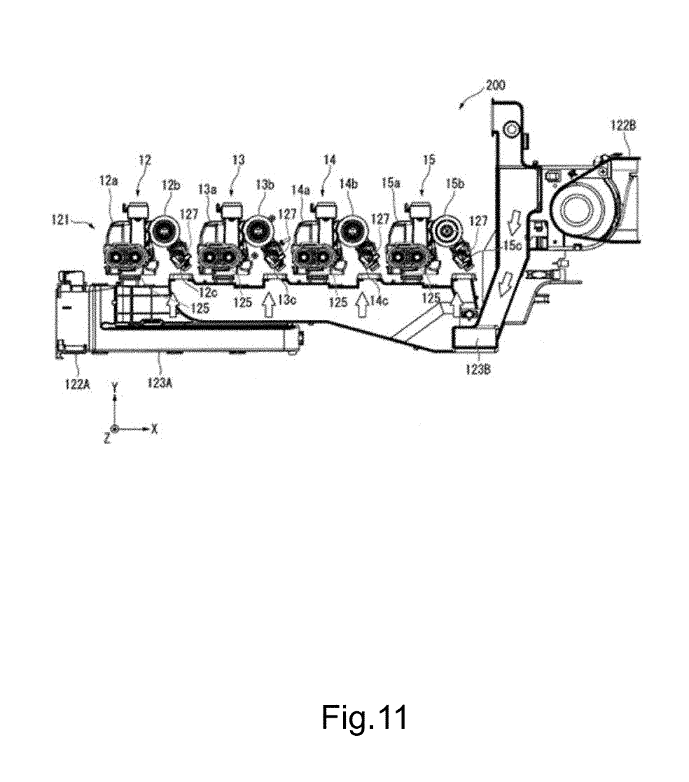

FIG. 9 is a perspective view showing the image forming units 12 to 15 and a ventilation mechanism 121 of the image forming apparatus 200 in a comparative embodiment. FIGS. 10 and 11 are front views each showing the image forming units 12 to 15 and the ventilation mechanism 121 of the image forming apparatus 200. It should be noted that configurations similar to those of the image forming apparatus 100 of the first embodiment will be denoted by the same reference symbols, and description thereof will be omitted.

As shown in FIG. 9, the ventilation mechanism 121 includes a first air intake unit 122A, a second air intake unit 122B, a first introduction path 123A, a second introduction path 123B, a first blower path 125 (see FIG. 10), a second blower path 127 (see FIG. 10), a first guide path (not shown in the figure), a second guide path 128B, a discharge path 129, a first air discharge unit 130A, a second air discharge unit 130B, and an ozonation treatment unit 131.

As shown in FIG. 10, the first blower path 125 is provided to each of the developer devices 12a to 15a. The second blower path 127 is provided to each of the charging devices 12c to 15c.

Next, a method of using the ventilation mechanism 121 of the image forming apparatus 200 will be described. As shown in FIG. 10, the first air intake unit 122A introduces air into the first introduction path 123A. The first introduction path 123A distributes and supplies the air to the front end portions of the first blower paths 125 of the developer devices 12a to 15a (see black arrows of FIG. 10). The supplied air flows from the front end portions of the first blower paths 125 toward the rear end portions thereof. The air cools the developer devices 12a to 15a. As shown in FIG. 9, air guided from the rear end portions of the first blower paths 125 (see FIG. 10) is sent to the first air discharge unit 130A via the first guide path (not shown in the figure). The air is discharged to the outside of the system by the first air discharge unit 130A (see black arrow of FIG. 9).

As shown in FIG. 11, the second air intake unit 122B introduces air into the second introduction path 123B. The second introduction path 123B distributes and supplies the air to the front end portions of the second blower paths 127 of the charging devices 12c to 15c (see the white arrows of FIG. 11). The supplied air flows from the front end portions of the second blower paths 127 toward the rear end portions thereof. Therefore, the inside of each of the charging devices 12c to 15c is ventilated. As shown in FIG. 9, air guided from the rear end portions of the second blower paths 127 (see FIG. 10) is sent to the discharge path 129 via the second guide path 128B. The air in the discharge path 129 is sent to the ozonation treatment unit 131 via the second air discharge unit 130B. After ozone is removed from the air, the air is discharged to the outside of the system (see white arrow of FIG. 9).

The image forming apparatus 200 includes the plurality of air intake units 122A and 122B and the plurality of air discharge units 130A and 130B. Therefore, the image forming apparatus 200 includes the ventilation mechanism 121 having a complicated structure and has disadvantage in reduction in size and cost of the apparatus.

### Second Embodiment

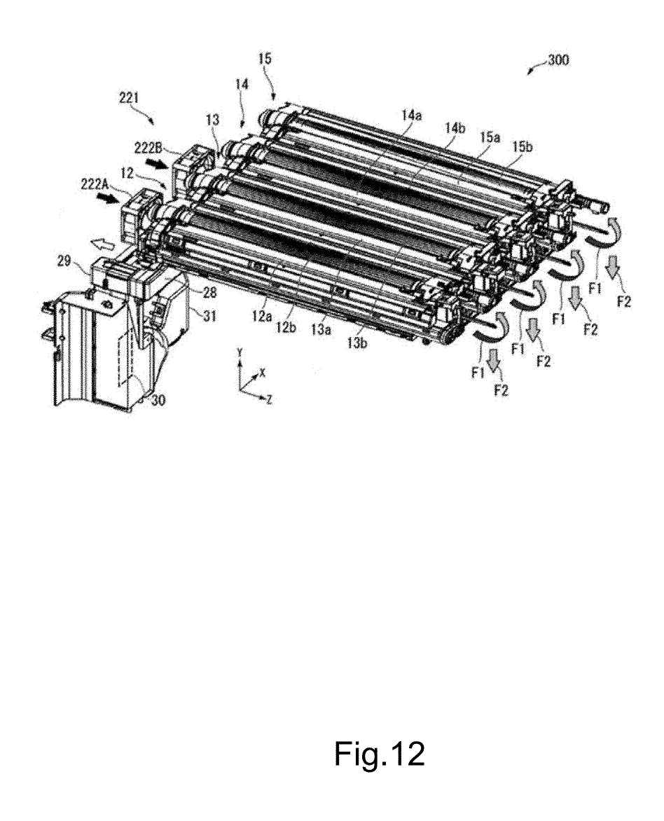

FIG. 12 is a perspective view of image forming units 12, 13, 14, and 15 and a ventilation mechanism 221 of an image forming apparatus 300 of a second embodiment. It should be noted that configurations similar to those of the image forming apparatus 100 of the first embodiment will be denoted by the same reference symbols, and description thereof will be omitted. As shown in FIG. 12, the ventilation mechanism 221 of the image forming apparatus 300 is different from the ventilation mechanism 21 of the image forming apparatus 100 in that the ventilation mechanism 221 includes a first air intake unit 222A and a second air intake unit 222B, instead of the air intake unit 22 (see FIG. 3).

The first air intake unit 222A can send air to the first blower paths 25 (see FIG. 5) of the developer devices 12a and 13a out of the developer devices 12a to 15a. The second air intake unit 222B can send air to the first blower paths 25 (see FIG. 5) of the developer devices 14a and 15a out of the developer devices 12a to 15a.

In the image forming apparatus 300, the structure of the ventilation mechanism 221 can be simplified as in the image forming apparatus 100 of the first embodiment. For example, the number of air discharge units 30 in the image forming apparatus 300 is smaller than that in the image forming apparatus 200 of the comparative embodiment. Therefore, the image forming apparatus 300 can achieve reduction in size of the apparatus. Further, since the structure of the ventilation mechanism 221 is simple, the image forming apparatus 300 can achieve reduction in cost. Since the image forming apparatus 300 includes the two air intake units 222A and 222B, the flow rate of air per developer device can be increased. Therefore, the image forming apparatus 300 is better than the image forming apparatus 100 of the first embodiment in terms of performance to cool the developer devices 12a to 15a.

It should be noted that the image forming apparatus of each embodiment includes the four image forming units 12 to 15, but the number of image forming units is not limited. If the first blower path can guide gas from the rear end portion of the developer device to the front end portion thereof, the structure thereof is not limited. If the connection path of the communication path can guide gas from the front end portion of the first blower path to the front end portion of the second blower path, the structure thereof is not limited. If the second blower path can guide gas from the front end portion of the charging device to the rear end portion thereof, the structure thereof is not limited. Therefore, the first blower path, the connection path, and the second blower path are not limited to the ducts and only need to have a structure that guides the flow of gas.

According to at least one of the embodiments described above, the air guided from the first blower path can be guided to the second blower path. Therefore, the structure of the ventilation mechanism can be simplified. For example, the number of air intake units and air discharge units can be reduced. Therefore, the image forming apparatus of each embodiment can achieve reduction in size of the apparatus. Further, since the ventilation mechanism has a simple structure, reduction in cost can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a photoreceptor;
a charging device that electrically charges a surface of the photoreceptor;
an exposing device that exposes the electrically-charged photoreceptor to light and forms an electrostatic latent image on the surface of the photoreceptor;
a developer device that develops the electrostatic latent image and forms a toner image on the surface of the photoreceptor;
an air intake unit that introduces air;
a first blower path that guides the air introduced by the air intake unit and cools the developer device;
a second blower path that ventilates an inside or a periphery of the charging device by using air guided from the first blower path; and
an air discharge unit that discharges air guided from the second blower path to an outside of a predetermined range.

2. The image forming apparatus according to claim 1, further comprising
a plurality of air intake units.

3. The image forming apparatus according to claim 1, further comprising
a communication path that guides the air guided from the first blower path to the second blower path.

4. The image forming apparatus according to claim 3, further comprising
a flow rate adjustment structure that is formed in the communication path and adjusts a flow rate of the air guided from the first blower path to the second blower path.

5. The image forming apparatus according to claim 4, wherein
the flow rate adjustment structure includes a discharge port, air within the communication path being partially discharged from the discharge port.

6. An image forming apparatus, comprising:
a rotary photoreceptor;
a charging device that electrically charges a surface of the photoreceptor;
an exposing device that exposes the electrically-charged photoreceptor to light and forms an electrostatic latent image on the surface of the photoreceptor;
a developer device that develops the electrostatic latent image and forms a toner image on the surface of the photoreceptor;
a casing that houses the photoreceptor, the charging device, the exposing device, and the developer device; and
a ventilation mechanism that
introduces air outside the casing from one end side of the photoreceptor in a rotation axis direction,
guides the introduced air to the developer device and cools the developer device,
guides the air introduced into the developer device from the developer device to the charging device and ventilates an inside or a periphery of the charging device, and
discharges the air introduced to the charging device from the one end side of the photoreceptor in the rotation axis direction to an outside of the casing.

7. The image forming apparatus according to claim 6, wherein
the ventilation mechanism includes a flow rate adjustment structure that adjusts a flow rate of the air guided from the developer device to the charging device.

8. The image forming apparatus according to claim 6, wherein
the ventilation mechanism includes
an air intake fan that is provided on the one end side of the photoreceptor in the rotation axis direction and introduces the air outside the casing,
a cooling duct that is provided in the developer device, and guides the air introduced by the air intake fan to the developer device and cools the developer device,
a ventilation duct that is provided in at least one of an inside or an outer surface portion of the charging device and ventilates the inside or the periphery of the charging device,
a connection duct that connects the cooling duct and the ventilation duct to each other and guides air from the cooling duct to the ventilation duct, and
a discharge fan that is provided on the one end side of the photoreceptor in the rotation axis direction and discharges the air guided from the inside or the periphery of the charging device to the outside of the casing.

9. The image forming apparatus according to claim 8, wherein
the cooling duct extends from the one end side of the photoreceptor in the rotation axis direction to the other end side of the photoreceptor in the rotation axis direction in the developer device and guides the air from the one end side to the other end side,
the ventilation duct extends from the one end side of the photoreceptor in the rotation axis direction to the other end side of the photoreceptor in the rotation axis direction in the inside or the periphery of the charging device and guides the air from the other end side to the one end side, and
the connection duct connects the other end side of the cooling duct and the other end side of the ventilation duct to each other and guides the air from the other end side of the cooling duct to the other end side of the ventilation duct.

10. The image forming apparatus according to claim 9, wherein
the connection duct includes a discharge port, the air guided from the other end side of the cooling duct to the other end side of the ventilation duct being partially discharged from the discharge port.

11. An image forming apparatus, comprising:
a photoreceptor;
a charging device that electrically charges a surface of the photoreceptor;
an exposing device that exposes the electrically-charged photoreceptor to light and forms an electrostatic latent image on the surface of the photoreceptor;
a developer device that develops the electrostatic latent image and forms a toner image on the surface of the photoreceptor;
an air intake unit that introduces air;
a first blower path that guides the air introduced by the air intake unit and cools the developer device;
a second blower path that ventilates an inside or a periphery of the charging device by using air guided from the first blower path; and
a communication path that guides the air guided from the first blower path to the second blower path, the communication path having a flow rate adjustment structure that adjusts a flow rate of the air from the first blower path to the second blower path.

12. The image forming apparatus according to claim 11, further comprising
an air discharge unit that discharges air guided from the second blower path to an outside of a predetermined range.

13. The image forming apparatus according to claim 12, further comprising
a plurality of air intake units.

14. The image forming apparatus according to claim 11, wherein
the flow rate adjustment structure includes a discharge port, air within the communication path being partially discharged from the discharge port.
